(19) United States
(12) Patent Application Publication
(10) Pub. No.: US 2017/0112203 A1
(43) Pub. Date: Apr. 27, 2017

(54) Retractable Headphone Visor and Air Filtration System

(71) Applicant: Evan John Kaye, Short Hills, NJ (US)

(72) Inventor: Evan John Kaye, Short Hills, NJ (US)

(21) Appl. No.: 14/919,707

(22) Filed: Oct. 21, 2015

(51) Int. Cl. A41D 13/11; A42B 1/24; A62B 18/00; G02B 27/01; A62B 9/00; H04R 1/10; G02B 27/14; A42B 1/00; A62B 23/02

(52) U.S. Cl. CPC A41D 13/1161; A42B 1/006; A42B 1/245; A41D 13/1184; A62B 18/003; A62B 23/02; A62B 9/003; H04R 1/1008; G02B 27/144; G02B 27/017; G02B 2027/0156; G02B 2027/0138

(57) ABSTRACT

The invention relates to a retractable collapsible visor system secured to the person's head, sometimes via headphones, such that the visor can be extended over the wearer's face for many utilities, including protecting the wearer against communicable diseases, displaying visual data, aiding with the privacy of spoken words, protecting against glare and sunlight.

### CROSS-REFERENCE TO RELATED APPLICATION

This application claims the benefit of U.S. Provisional Application No. 62/066,454, filed Oct. 21, 2014.

### FIELD OF THE INVENTION

The invention relates to a retractable collapsible visor system secured to the person's head, sometimes via headphones, such that the visor can be extended over the wearer's face for many utilities, including protecting the wearer against communicable diseases, displaying visual data, aiding with the privacy of spoken words, protecting against glare and sunlight.

### BACKGROUND OF THE INVENTION

Over time people have become more comfortable wearing items in and around their head. Since ancient times people have worn head garments to keep warm or to provide shade to their face. They would also wear helmets to protect their heads, as is common today too. More recently society has become used to the wearing of spectacles for the correction of refractive problems, or sunglasses for the comfort and eye protection in the setting of bright daylight. With the invention of headphones some decades ago, people were able to start enjoying a private listening experience in both ears comfortably for long periods of time, but it was not until portable music devices some such as the Sony Walkman some decades later that people could enjoy the convenience of headphones in a portable manner. Even though ear pieces have changed and people have the option of putting small earpieces in their ears without the large bulkiness of standard headphones, many still opt for the sound isolating qualities that large ear-covering headphones offer, along with the comfort factor where they rest securely over the person's head. The form of the standard headphones has changed remarkably little over the past half century.

There has also been increased interest in immersive experiences over the past few decades where 3D visual material is displayed by way of head mounted displays, often coupled with an immersive audio experience, accelerometers, and gyroscopes which can provide input to the rendering engine to make the visual and audio components more realistic. These head mounted displayed require two separate images be displayed for each eye to give the 3D effect, and will obscure the rest of someone's visual field. A variation of this is augmented reality where visuals are projected to someone's eyes and matched to what someone is seeing in the rest of their vision. Both experiences usually require significant hardware around the person's head (unless the entire room that they are in is fitted with screens). Google Glass and other wearables that provide someone with a visual display as part of the functionality of the glasses has also become more commonplace. For these reasons, and trends, we will continue to see the widespread adoption of wearables around the head, and it will become acceptable in society to wear more devices around a person's head.

Masks have also become commonplace in some parts of the world, as airborne transmissible diseases have become more widespread due to the congested population in cities, public transportation, and global travel. Sporadic outbreaks, such as SARS, influenza, swine influenza, and others have been triggers for the widespread adoption of masks, particularly in Asia. In the United States people are still less likely to wear masks in public, but the trend toward protecting oneself against airborne transmissible diseases is strong, and alternatives, or more effective devices, other than masks are needed.

Seasonal allergies is also another reason why people would want to filter the air around their face in some way. Some have such severe allergies that they have needed a special suit (or “bubble”) to function in. There is no wearable device nowadays that allows for someone to effectively filter the air in the proximity of their face while still blending into society with an obscure apparatus. Another trend has been the increased adoption of mobile phones. Society used to find it necessary to have public phones in booths so as to maintain the caller's privacy, reduce the ambient noise for the telephone call, and not interrupt people in the vicinity with the noise of the conversation. Now with mobile phones it has become commonplace for people to engage in loud telephone conversations without consideration for their privacy or for the interruption of others around them. There is, currently, no effective wearable device that exists that can maintain someone's privacy during a phone conversation, or other recording of their voice, and easily have its configuration changed by the user to become less obstructive to their face so that someone can easily interact with them. The closest wearable device in the art is a helmet with a visor that has both earphones and a microphone, yet the apparatus does not easily collapse to a state where it is not obscuring the person's face in a way that allows them to interact with the people around them effectively.

### SUMMARY THE INVENTION

In one aspect of the invention a wearable device on the head allows for a collapsible visor system to be pulled down over the face creating a private airspace in the proximity of the face and allowing a flow of filtered air to be directed over the person's face for breathing. The visor system can be fully transparent or have tinted or opaque regions. It may also be fitted with an LCD display system, and have lenses that move down closer to someone's eyes so that they can view the LCD screen effectively. The visor system may be able to be pulled down partially or fully, or pushed all the way up so as not to obscure the face at all. The retractable visor system may also be removable from the headphone structure and attached at will.

### DESCRIPTION OF THE FIGURES

FIG. 1 shows a front view of a headphone with visor panels attached and fully retracted;

FIG. 2 shows an oblique view of a headphone with visor panels attached and fully extended;

FIG. 3 shows an oblique view of a headphone with visor panels attached and fully retracted;

FIGS. 4A-D show multiple line drawings of the headphone visor apparatus as it sits on someone's head and allows for air to be directed through fans over someone's face.

### DETAILED DESCRIPTION OF THE PREFERRED EMBODIMENT

The invention is described in detail with particular reference to a certain preferred embodiment, but within the spirit and scope of the invention, it is not limited to such an embodiment. It will be apparent to those of skill in the art that various features, variations, and modifications can be included or excluded, within the limits defined by the claims and the requirements of a particular use.

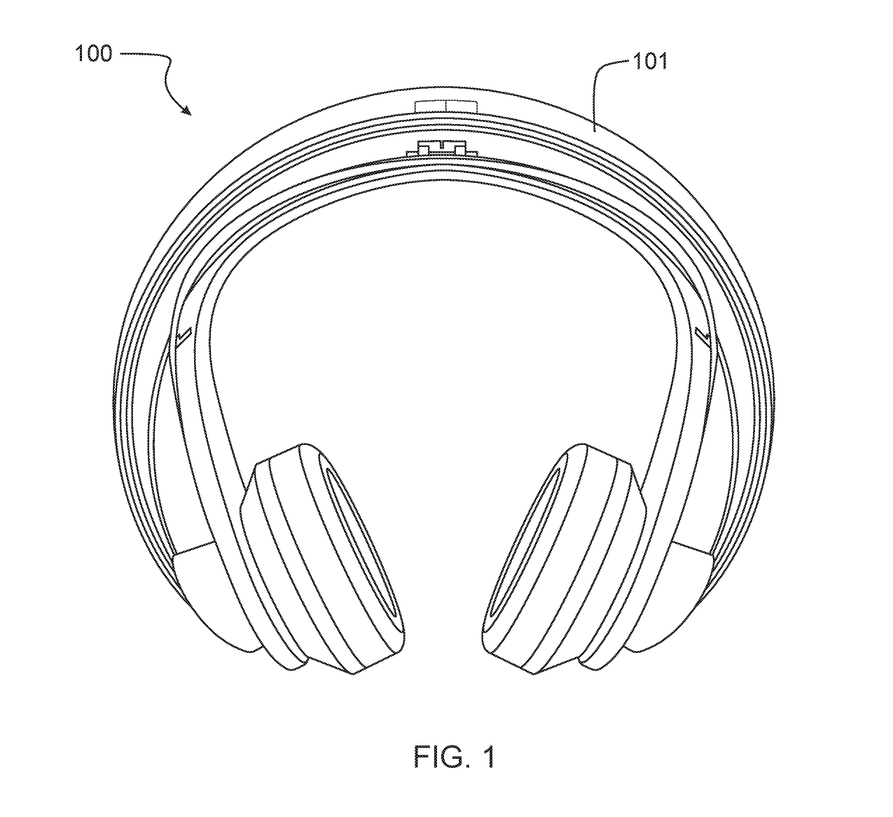

With reference to FIG. 1, a front view of a headphone 100 with visor panels attached 101 and fully retracted is shown. The headphone is a standard configuration headphone that a user typically wears and with all visor panels fully retracted it does not obscure their vision, nor does it interfere with the viewing of the person's face by another.

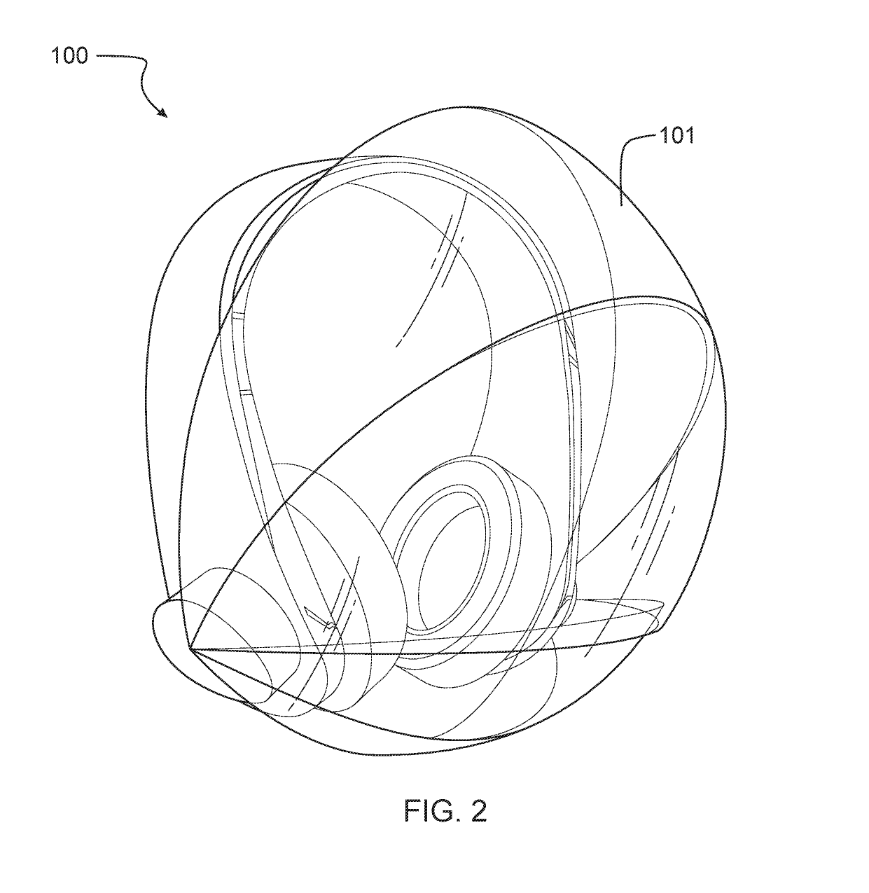

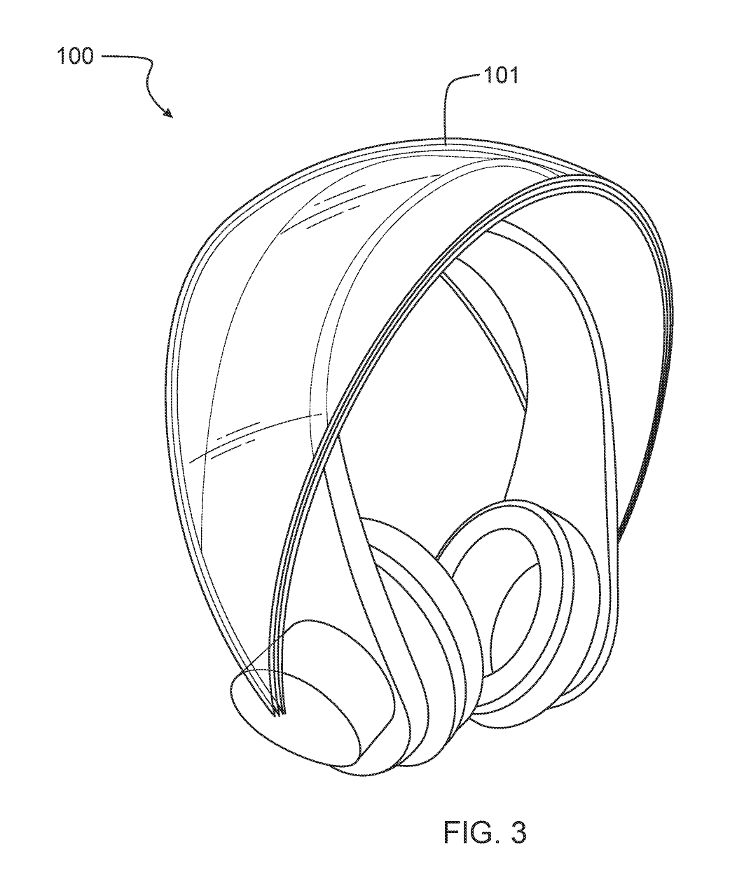

With reference to FIG. 2, an oblique view of a headphone 100 with visor panels attached 101 and fully extended is shown. It can be appreciated from this view that a person's face would be fully encapsulated within the semi-bubble that is formed. It does not form a perfect seal around the face, but rather air can be directed by way of a fan and pipe system, from the headphone ear cups, up and into the visor and then release with a forward flow so as to pass over the person's face, then down and out. The air should be purified or filtered along its path either by physical filters, such as used for medical masks, or by ionizing filters, pollen filters or a combination of them. It may also be possible to provide humidity to the air in dry environments through a humidifier built into the apparatus. In areas where someone might be working in a condition with a pungent ambient smell, the use of fragrances can also be introduced into the air as it passes through the apparatus.

With reference to FIG. 3, an oblique view of a headphone 100 with visor panels attached 101 and fully retracted is shown. As with FIG. 1 it can be appreciated that the visor system does not obscure the person's vision, nor does it interfere with the viewing of the person's face by another.

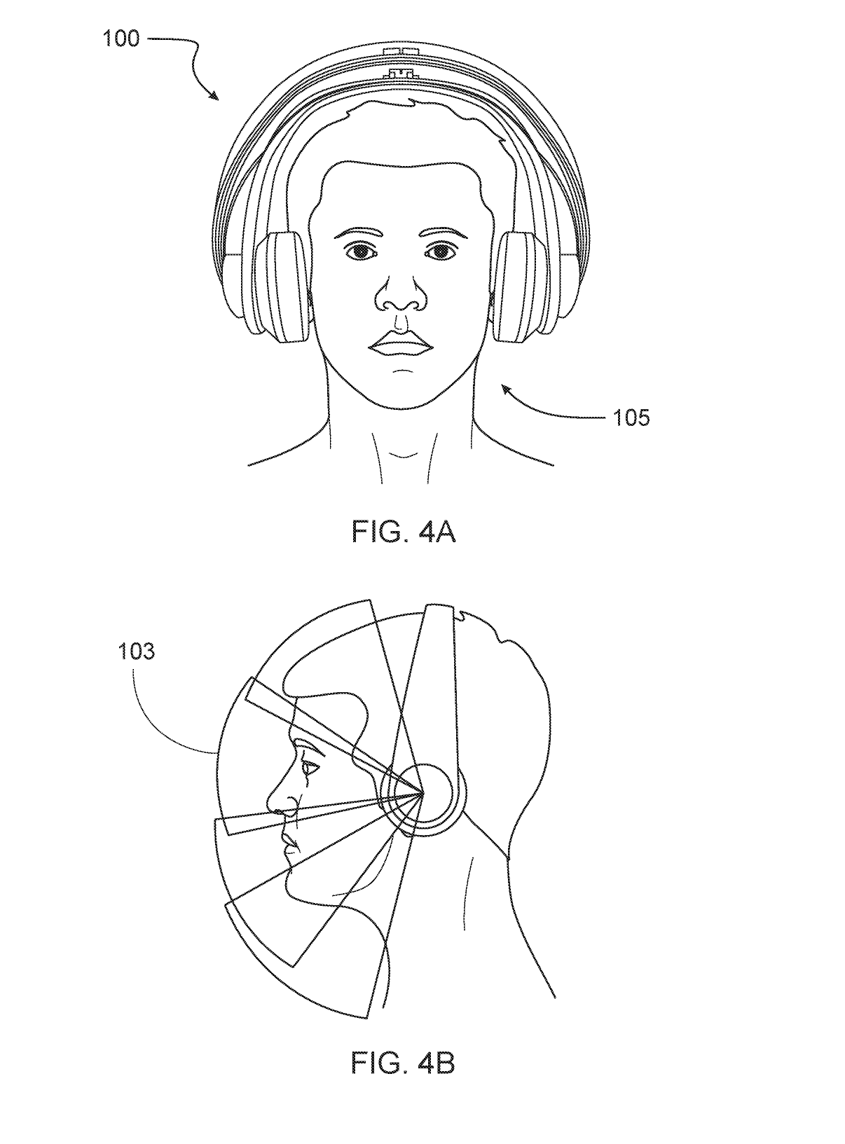

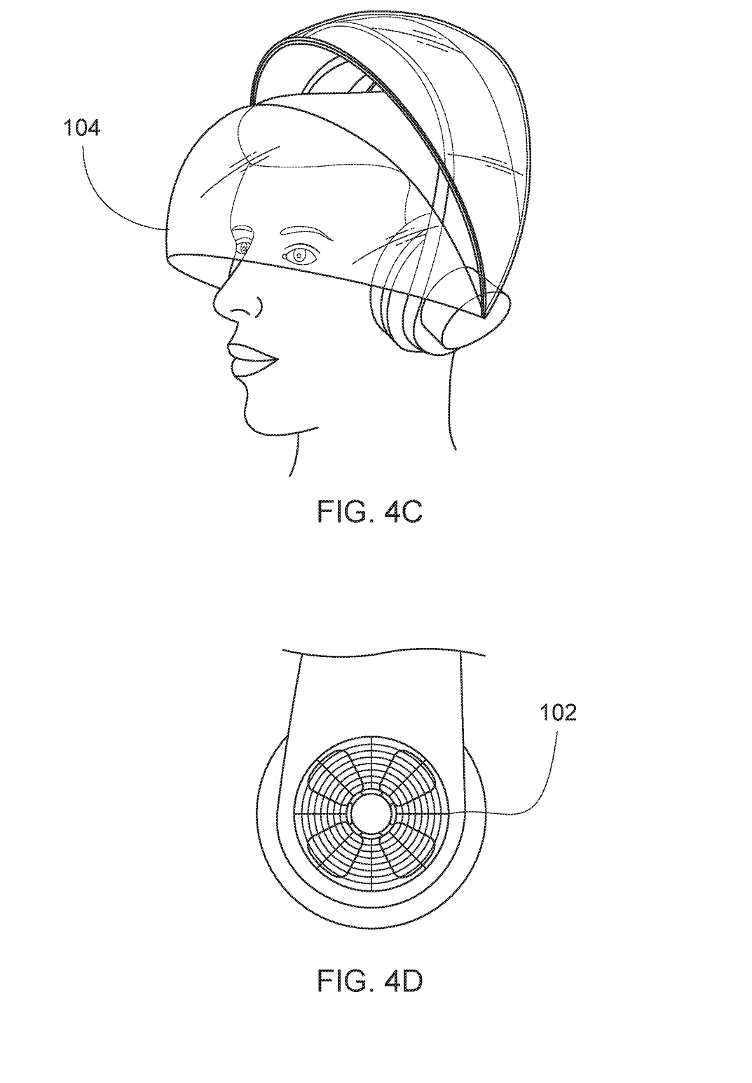

With reference to FIGS. 4A-D, multiple line drawings of the headphone visor apparatus as it sits on someone's head 105 and allows for air to be directed through fans 102 over someone's face.

The aforementioned LCD screen 103, or any other type of similar display, can be built into one or more of the visor panels. Another way of allowing someone to see the images on the panels is to project the images from mini-projectors that are incorporated into the sides of the headphone apparatus, ideally one projector for each eye.

The visor system may also be coated with a one-way mirror system, such that a reflective substance reflects ambient light away from the visor but allows some of it to pass through. An internal light may light up the persons face if they wish to be seen, but they can switch off the internal light if they prefer their face is not seen.

Since the extended visor system provides a degree of soundproofing, the person may speak openly into the extended visor system and microphones in the headphone portion will pick up the person's voice. Audio signal processing can be used to eliminate any “bubble” echo sound in their recording or transmission of their voice to another person.

A camera system of one or more cameras 104 may also be used to record the internal reflection of the person's face in the visor, and reconstitute the image so that it can appear as a normal form, not distorted in any way, in a video conference setting, or if they wish to record their face for another reason. The camera system may also comprise wide angle lenses that directly record light from the person's face, exclusively or in addition to the cameras recording reflected light from the visor.

I claim:

1. A collapsible visor system that secures to a person's head, comprising:
a headphones component capable of producing sounds in close approximation with the person's ears;
a visor component which articulates with the headphones component and can be moved over or above regions of the person's face.

2. A collapsible visor system as in claim 1, wherein the visor comprises a plurality of panels that cover one another in the retracted position.

3. A collapsible visor system as in claim 1, where the visor component contains a one-way mirror system such that the person's face can be hidden from others around them but dynamically illuminated if they wish to be seen.

4. A collapsible visor system as in claim 1, where the visor component contains an electronic screen.

5. A collapsible visor system as in claim 4, where the electronic screen is an LCD screen.

6. A collapsible visor system as in claim 1, where the visor component reflects images projected on it back into the wearer's eyes, from mini-projectors incorporated into the sides of the headphone apparatus.

7. A standard audio headphones apparatus, further comprising a retractable visor that can reveal or cover essentially all of the person's face.

8. The audio headphones apparatus of claim 7, further comprising an active airflow system which ensures direction of airflow beneath the visor.

9. The audio headphones apparatus of claim 8, wherein the active airflow system is mediated by one or more fans.

10. The audio headphones apparatus of claim 9, wherein the active airflow system contains an air purification component.

11. Headphones that are used to play audio into a person's ears, comprising:
speakers within ear cups that are in close proximity to the person's ears;
a camera system that has at least one camera that can record the person's face by capturing the light reflected of a surface attached to the headphones.

12. The headphones of claim 11, wherein the camera system digitally adjusts for distortion.

13. The headphones of claim 11, wherein the at least one camera is a plurality of cameras.

14. The headphones of claim 13, wherein the camera system reconstitutes the image of the person's face from a plurality of camera sources.
